(19) United States
(12) Patent Application Publication
(10) Pub. No.: US 2013/0214906 A1
(43) Pub. Date: Aug. 22, 2013

(54) System And Method For Automatically Transmitting Messages To A Mobile Radio Device

(71) Applicant: Ernst Wojak, Munchen (DE)

(72) Inventor: Ernst Wojak, Munchen (DE)

(21) Appl. No.: 13/430,344

(22) Filed: Mar. 26, 2012

(30) Foreign Application Priority Data
Feb. 22, 2012 (DE) 10 2012 101 420.5
Feb. 22, 2012 (EP) 12 156 568.3

(51) Int. Cl. G06K 7/01; H04W 4/00

(52) U.S. Cl. 340/10.1

(57) ABSTRACT

The invention relates to a system and a method for automatically transmitting at least one message via at least one mobile radio network to at least one mobile radio device, including at least one detecting device disposed at an entrance to an institution, which is configured to detect passage of the entrance by a user of the mobile radio device as a result of an interaction of an entrance element of the user with the detecting device independent of a mobile radio network and to communicate at least one triggering signal as a result of detection of the passage, and including a transmitting device coupled to the detecting device, which is configured to receive the triggering signal and to communicate the at least one message to the mobile radio device as a result of the reception of the triggering signal.

The present invention relates to a system for automatically transmitting at least one message to at least one mobile radio device according to claim 1 as well as to a method for automatically transmitting at least one message to at least one mobile radio device according to claim 9.

From the general prior art, it is sufficiently known to use mobile radio devices, for example mobile phones and/or so-called tablet computers, with access to a mobile radio network for positioning. To this, the mobile radio devices can be coupled to a positioning system, for example GPS (Global Positioning System). Thereby, it is possible that a user of such a mobile radio device determines his position on the earth and for example is able to navigate to another position.

Moreover, it is known to use this possibility of positioning of the mobile radio devices in order to trigger actions or operations of the mobile radio device. For example, if the user of the mobile radio device reaches a presettable position with the mobile radio device, thus, a for example optical and/or acoustical signal is communicated to the user by means of the mobile radio device. The signal makes the user aware of the fact that he is located in the presettable or preset position. Thereby, the user can for example be reminded of tasks and be made aware of these tasks, which he intends or intended to do in this presettable position.

However, these reminders and indications are to be specified and preset by the user himself. In addition, the user has to search for institutions in the environment of his position by himself for doing his tasks. Moreover, it is possible that the user does not find the desired institutions for example because of unbeneficial search requests, although they are in relative close vicinity. This implies that the user does not or only elaborately and hardly orient himself in his environment and optionally has to travel very large distances for doing his tasks or even is not able to do his tasks at all.

Therefore, it is the object of the present invention to provide a system and a method for automatically transmitting at least one message to at least one mobile radio device, which allow a particularly simple and adequate orientation of the user of the mobile radio device in his environment.

This object is solved by a system having the features of claim 1 as well as by a method having the features of claim 9. Advantageous configurations with convenient and non-trivial developments of the invention are specified in the remaining claims.

The first aspect of the invention relates to a system for automatically transmitting at least one message via at least one mobile radio network to at least one mobile radio device coupled to the mobile radio network. The system includes at least one detecting device disposed at an entrance to an institution. The detecting device is configured to detect passage of the entrance by a user of the mobile radio device as a result of an interaction of an entrance element of the user with the detecting device independent of a mobile radio network and to communicate at least one triggering signal as a result of detecting the passage.

Further, the system includes a transmitting device coupled to the detecting device. The transmitting device is configured to receive the triggering signal of the detecting device and to communicate the at least one message to the mobile radio device as a result of reception of the triggering signal.

The system according to the invention thus allows the precise detection that the user of the mobile radio device entered the institution via its entrance or has got to the institution. As a result, the user can be provided with adequate information to the institution and therefore to the environment of the user by means of the message communicated to his mobile radio device, without the user having to get active on his own accord and search for information about his environment about the institution. The system according to the invention thus allows particularly simple and adequate orientation of the user in his current environment.

With the system according to the invention, the precision of the detection of the passage of the entrance by the user is higher in particular with respect to positioning via a satellite-based positioning system such that the at least one message can also only be communicated to the mobile radio device if the user actually has got to the institution. Thus, the user can be particularly precisely informed about his environment without having to search for information about his environment by himself. In other words, the interaction of the entrance element with the detecting device presents a triggering event, as a result of which the triggering signal is communicated and the communication of the at least one message is triggered without further assistance of the user. Thereby, the user can be individually provided with the information to his environment only if he actually is in or at the institution.

The entrance is for example a person entrance in the form of a lock, a portal or a gateway, a turnstile or the like, via which the user can enter the institution or get to the institution. For example, the entrance can also be a thoroughfare for a vehicle, for example for a passenger car, a commercial vehicle, a rail vehicle or for another surface vehicle, for a water craft such as for example a ship, a tunnel, a bridge to a ship or the like. The entrance can also be an entrance to an area, for example a skiing area. Therein, the entrance is for example an entrance to a ski-lift.

By passing the entrance, the user can then be provided with corresponding information to the institution and thereby to his environment by means of the at least one message.

The institution is e.g. an exhibition or exhibition grounds and/or at least one exhibition building, an exhibition hall, a sports stadium, a sports hall, a vehicle, in particular a surface vehicle, an aircraft or a water craft. The institution can also be a traffic section of a traffic institution, in particular a road section of a road network, a highway section of a highway or the like.

If the institution is for example an exhibition, thus, the user can be provided with information about the exhibition, its in particular direct environment and thus about roads, in particular highways, extending in the vicinity of the exhibition, its exhibitors and/or its exhibited products in specific and adequate manner by means of the at least one message. It is also possible to inform the user with information about events and in particular about the location and the time of the events, which are performed in or at the exhibition.

If the institution is for example a highway section, thus, the user can be informed about a traffic situation on the highway section traveled by the user in specific and adequate manner by means of the at least one message. Thereby, it is for example possible to warn the user about a preceding traffic jam and/or about a preceding dangerous situation, which the user can then bypass.

The system according to the invention in addition allows the communication of multiple messages as well as the communication of at least one message to multiple mobile radio devices via the mobile radio network. Thereby, it is possible to provide respective users of the corresponding mobile radio devices with information about their respective environment or about the institution in inexpensive, contemporary, purposeful and individual manner, from which a particularly simple orientation of the users results.

In advantageous development, the entrance element is an entrance ticket formed from paper and/or plastic. This allows precise detection of the passage of the entrance by the user. Therein, the interaction of the entrance ticket is performed with the aid of a person, in particular the user, such that the entrance ticket and the detecting device can interact.

Alternatively or additionally, the entrance element can also be a number and/or letter code, which is to be input into the detecting device. It is also possible that the entrance element is at least one fingerprint, in particular of the user.

In another embodiment of the invention, the entrance element and the detecting device are configured to interact with each other via electromagnetic waves for detecting the passage of the entrance. This allows a particularly simple, precise detection of the passage of the entrance by the user, very comfortable for the user, since the interaction between the detecting device and the entrance element can be effected without assistance of a person and in particular without assistance of the user and in particular contact-less. For example, the user can simply carry the entrance element in a bag or similar container in comfortable manner and pass the entrance with the entrance element, wherein the detecting device and the entrance element interact with each other via electromagnetic waves

Preferably, the entrance element includes at least one RFID chip (RFID—Radio Frequency Identification) for interacting with the detecting device via electromagnetic waves. Thereby, the detection of the passage comfortable for the user can be realized in inexpensive as well as space-saving manner.

Furthermore, it can be provided that the entrance element and the detecting device are configured to interact with each other via the so-called near field communication (NFC—Near Field Communication) for detecting the passage of the entrance. The near field communication is an international transmission standard for contact-less exchange of data via short distances. By means of the near field communication, for example, cashless payments can be performed such that the user can for example pay the entrance fee via the near field communication at the same time with the passage of the entrance.

The entrance element can also be integrated in the mobile radio device, wherein the interaction between the mobile radio device functioning as the entrance element and the detecting device is performed independently of the mobile radio network. In connection with the near field communication, therein, a chip or similar element is integrated in the mobile radio device for performing the near field communication such that the mobile radio device as the entrance element can interact with the detecting device via the near field communication.

The institution can also be a parking lot, a parking structure or similar parking lot institution, wherein the detecting device is for example a payment automat, at which the user can pay costs for parking his vehicle, in particular his motor vehicle or his motorcycle. Therein, the user pays by means of the entrance element, which can be a payment card, in particular a credit card or EC card. The payment can in particular be effected via the near field communication, wherein it is preferably provided that the entrance element is integrated in the mobile radio device and the user thus pays cashless by means of his mobile radio device via the near field communication. As a result, the message can be communicated to the user in order to supply him with information about the environment of the parking lot institution.

The institution can also be a so-called car sharing institution, which includes at least one vehicle, in particular a plurality of vehicles, as the respective entrance. The vehicles of the car sharing institution can be used by different persons subscribing to or registered with the car sharing institution. The vehicles are preferably motor vehicles.

For using one of the vehicles, the interaction of the entrance element of the user with the detecting device disposed on or in the vehicle (entrance) occurs. Herein, the entrance element is for example a subscription card of the car sharing institution. The entrance element can also be integrated in the mobile radio device. Within the scope of the interaction, which is for example performed via the near field communication, payment or preparation of payment of the use of the corresponding vehicle by the user is also effected. Within the scope of the interaction, the user communicates payment information to the detecting device, which communicates it to a computing device of the system. After traveled distance and/or a utilization period of the vehicle by the user, then, the utilization costs are calculated.

As a result of the interaction of the entrance element with the detecting device of the vehicle, the position of which is for example detected by means of a positioning system and therefore is known, the message with information about the current environment of the vehicle and thus of the user is communicated to the user.

By linking the passage of the entrance of the institution to the communication of the at least one message, the time at which the user has passed the entrance can also be taken into account such that the content of the at least one message can be matched correspondingly to the time or the time of day, at which the user gets to the institution. Thus, it is possible to inform the user about events to be performed in the future or the like. Information of the user about already past events or the like can be avoided.

In further advantageous development of the invention, the entrance element and the detecting device are configured to interact with each other such that the entrance element can at least partially be inserted into a receiving opening of the detecting device. Thereby, an inexpensive yet very precise detection of the passage of the entrance is allowed.

To this, the entrance element for example formed as an entrance ticket can be inserted into a receiving opening, in particular a slot, of the detecting device and/or be moved, in particular pulled, through the receiving opening, in particular the slot.

In a further advantageous embodiment of the invention, the entrance element has at least one optically detectable pattern, in particular a bar code, wherein the detecting device includes at least one optical detecting means, by means of which the optical pattern of the entrance element can be detected for interaction of the detecting device with the entrance element. Thereby, a particularly simple and fast detection of the passage of the entrance by the user is allowed. The pattern is for example disposed on the entrance element formed as an entrance ticket, in particular printed on it.

For example, the optically detectable pattern is a QR code (QR—quick response). Therein, it is a two dimensional code, by means of which the passage of the entrance as well as optionally further information of the user is detectable.

The pattern can also be provided on an electronic screen, in particular on a screen of the mobile radio device. For example, the entrance element can be communicated to the mobile radio device and thus to the user via the mobile radio network, wherein the interaction itself is independent of the mobile radio network.

For interaction of the detecting device with the optical pattern of the entrance element, the entrance element or its optical pattern is moved into a detection range of the optical detecting means such that the optical detecting means can detect the optical pattern.

By this purposeful detection of the passage of the entrance by the user, it is in particular also possible to detect the actual presence of the user and thus to perform for example counting of persons in or at the institution. It is also possible to communicate an indication message, in particular an email or the like, to the operator of the institution, in particular to the organizer, and/or to at least one of the exhibitors of the exhibition as a result of the detection of the passage of the entrance. Therein, the indication message can be communicated to a mobile radio device of the operator of the institution via a mobile radio network. Thereby, the operator of the institution can be informed about the fact that the user of the mobile radio device has entered the institution or has got to the institution.

In a further, particularly advantageous embodiment of the invention, the system includes at least one further detecting device, wherein the further detecting device and the mobile radio device are configured to determine a relative position of the mobile radio device to the institution by means of a positioning system. In other words, it is thus possible to determine a current position of the mobile radio device and thereby of the user at or in the institution in order to thus purposefully provide the user with adequate information to his closer environment. To this, for example, at least one further message is communicated to the user depending on his position relative to the institution detected by means of the further detecting device.

Further, thereby, it is possible in simple manner comfortable for the user to detect the exit of the user from the institution. For this detection of the exit, for example, further interaction of the user and/or of the entrance element with a component of the system is not provided and required.

For detecting the exit of the user from the institution, for example, at least one presettable threshold value is provided, which characterizes a distance of the mobile radio device or of the user from the institution, in particular from the entrance.

If the distance of the mobile radio device and thereby of the user from the institution determined by means of the further detecting device exceeds the presettable threshold value, thus, the exit of the user from the institution can be inferred thereby. Thereupon, the communication of further messages to the mobile radio device by means of the transmitting device via the mobile radio network can be avoided.

Preferably, the positioning system is a satellite-based positioning system, in particular GPS (Global Positioning System). Thereby, sufficiently precise as well as inexpensive detection of the current position of the mobile radio device and thus of the user is possible.

By means of the presence detection or control and preferably in combination with the detection of the exit from the institution, it is for example possible within the scope of a shareholders' meeting of shareholders, in particular stockholders, of an enterprise or the like taking place in or at the institution to examine if the user of the mobile radio device is still present in a vote within the scope of the meeting. Alternatively or additionally, it can be detected if the user is still in or at the institution at a certain time. Optionally, in this context, a message can also be passed to the user of the mobile radio device that the vote is imminent.

The positioning system for detecting the current position of the user relative to the institution can for example also be a wireless data transmission network, for example WLAN (wireless local area network). Thus, for example, it is possible at or in institutions, in which a satellite-based positioning system does not work due to the ceilings and/or walls shielding the user, to detect the user or the relative position of him to the institution and as a result to adequately provide him with information. The wireless data transmission network is thus a local wireless data transmission network associated with the institution, which allows wireless data transmission in a local network in or at the institution.

Advantageously, the local, wireless data transmission network of the institution can also be used by the user of the mobile radio device for navigating in or at the institution. In other words, it is possible for the user that he determines the current relative position of his mobile radio device and thereby his own current relative position to the institution by means of his mobile radio device via the local wireless data transmission network and can obtain information as a result, how, i.e. on which way, he gets to a desired location, for example to a desired exhibition stand, of the institution.

To this, direction indications such as for example arrows or a route can be displayed to the user on a screen of the mobile radio device, in order that the user finds the desired location in simple and comfortable as well as in safe manner.

In this manner, the user can for example be provided with direction indications in a dangerous situation, which guide him to the closest and/or best reachable emergency exit.

The second aspect of the invention relates to a method for automatically transmitting at least one message via at least one mobile radio network to at least one mobile radio device, in which passage of an entrance to an institution by a user of the mobile radio device is detected by means of a detecting device disposed at the entrance as a result of an interaction of the entrance element of the user with the detecting device independent of the mobile radio network.

Furthermore, at least one triggering signal is communicated by means of the detecting device as a result of detecting the passage. Further, the triggering signal is received by a transmitting device coupled to the detecting device. Thereupon, the at least one message is communicated to the mobile radio device by means of the transmitting device as a result of reception of the triggering signal. Advantageous developments of the first aspect of the invention are to be considered as advantageous developments of the second aspect of the invention, and vice versa.

The method according to the invention allows the purposeful and adequate communication of the at least one message to the user and thus the communication of purposeful information about the environment of the user to him.

Therein, the communication of the at least one message depending on the triggering signal and thus depending on the passage of the entrance is advantageous in that the user does not have to get active by himself and for example start or operate an application of his mobile radio device. In other words, the user passively obtains the at least one message. Thus, the user does not have to actively search for information to his environment, and therefore can orient himself in or at the institution in simple and comfortable manner.

Preferably, a picture message and/or a text message, in particular an email, is communicated as the at least one message. Thereby, information for example about events, products, buildings, institutions and/or the like in the environment of the user can be communicated to him in clear manner. However, the message can also be an SMS (Short Message Service) or an MMS (Multimedia Messaging Service) or an acoustic message.

The mobile radio device is for example a mobile phone, a tablet PC and/or another electronic appliance preferably with a screen, on which the message formed as a text and/or picture message can be displayed. This allows a particularly comfortable and simple orientation of the user in the institution or in his environment.

In a particularly advantageous embodiment of the invention, the at least one message is communicated depending on at least one presettable, user-specific specification. The user-specific specification for example relates to information about a product, types of products, services and/or other categories in or at the institution, which he can specify or select temporally before passing the entrance. According to user-specific specification, thus, different and adequate information to the institution can be communicated to different users, who get to the institution, without the respective user having to actively search for it. Thereby, in particular provision of the respective user with information according to interests is possible. The content of the at least one message, i.e. the information that is communicated to the user by means of the at least one message, can for example be generated by the respective providers of products, services and/or the like in or at the institution and for example be stored in the transmitting device.

Thus, the transmitting device can provide the respective user with information in particular depending on the at least one, user-specific specification in adequate and purposeful manner. Moreover, it is possible to supply the user with information about time postponements of events as well as hazard notes. Such hazard notes are in particular helpful in aircrafts, ships, trains or else stationary institutions such as tunnels in order to communicate a message in case of need, via which escape passageway the user of the mobile radio device can best get into safety.

In a further embodiment of the invention, at least one further message is communicated to the mobile radio device via the mobile radio network. Thus, it is possible to keep the user informed about variations in his environment, in particular with respect to events, traffic situations, dangerous situations or the like without the user having to get active by himself.

Preferably, the at least one further message is communicated depending on the time and/or on a position of the mobile radio device relative to the institution, in particular to the entrance. Thus, it is for example possible to make the user aware of events imminent in time and/or of buildings, products, services or the like at or in the institution and in proximity to the user in adequate and purposeful manner. Thereby, the information about the environment of the user can be filtered and be restricted to a partial area of the entire institution according to where the user resides in or at the institution.

In particular, it is advantageous to link the communication of the message, in particular of the further message, to a presettable period of time of an occurrence in or at the institution. Thus, for example, shortly before the end or at the end of the occurrence, the message can be sent to the user in order to provide the user with information and/or indications or the like.

If the institution is for example the above mentioned ski-lift, thus, the occurrence can be the transport of the user from the beginning or entrance of the ski-lift to the end or exit of the ski-lift, and the period of time can be the transport period of the user from the entrance to the exit. Shortly before the end of the transport period (period of time) and thus shortly before the end of the transport (occurrence), the message can be sent to the user that the transport soon ends and that he should prepare for exiting the ski-lift

The period of time can also be a parking period, for which the user has paid and over which the user is allowed to park his vehicle on the above mentioned parking lot institution. Before expiration of the parking period, the message and therefore the indication can be communicated to the user that the parking period expires such that he is able to timely remove his vehicle from the parking institution or remargin for further parking period.

In a further embodiment of the invention, the communication of messages via mobile radio to the mobile radio device is communicated depending on a position of the mobile radio device relative to the institution, in particular the entrance. Thus, it is for example possible not to provide any further messages to the user if he has exited the institution. A very high comfort for the user results from it, since he does not have to get active for terminating the determination of messages.

Preferably, the communication of messages is terminated if a distance of the mobile radio device from the institution, in particular from the entrance, exceeds a presettable threshold value. Upon exceeding the presettable threshold value, exit of the user from the institution can be inferred in defined manner such that the communication of further messages to the mobile radio device can be precisely avoided.

In a further, advantageous embodiment, the communication of messages via mobile radio to the mobile radio device is terminated depending on the time. Thereby, it can be avoided in particularly comfortable manner for the user to inform the user with information for example about already closed institutions and/or terminated events. This benefits the simple orientation of the user.

Further advantages, features and details of the invention are apparent from the following description of a preferred embodiment as well as based on the drawing. The features and feature combinations mentioned above in the description as well as the features and feature combinations mentioned below in the description of figures and/or shown in the figures alone are usable not only in the respectively specified combination, but also in other combinations or else alone without departing from the scope of the invention.

The drawing shows in:

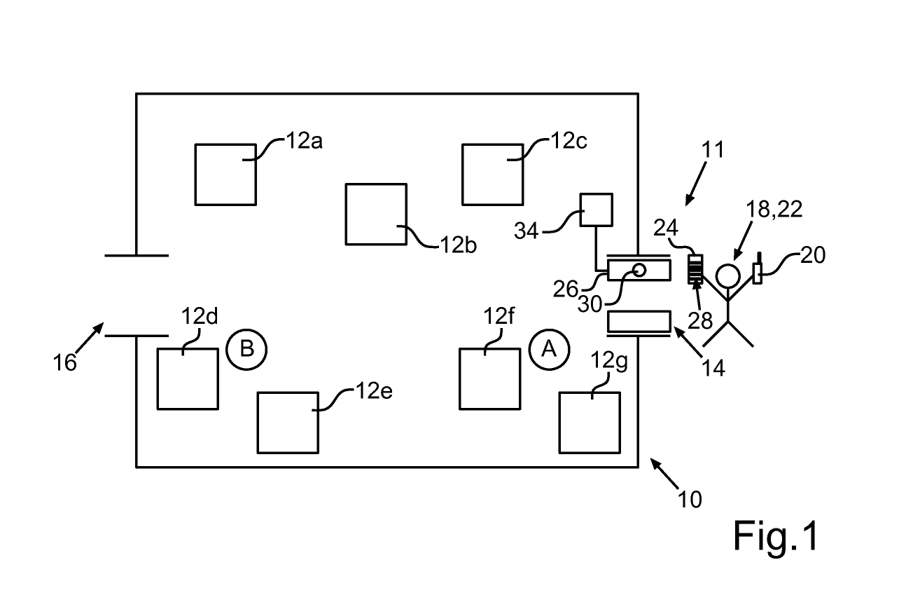

FIG. 1 a schematic illustration of a system for automatically transmitting messages to at least one mobile radio device, with a detecting device disposed at an entrance to an institution and with a transmitting device coupled to the detecting device, by means of which at least one message is to be communicated to the mobile radio device as a result of passage of the entrance by a user of the mobile radio device; and

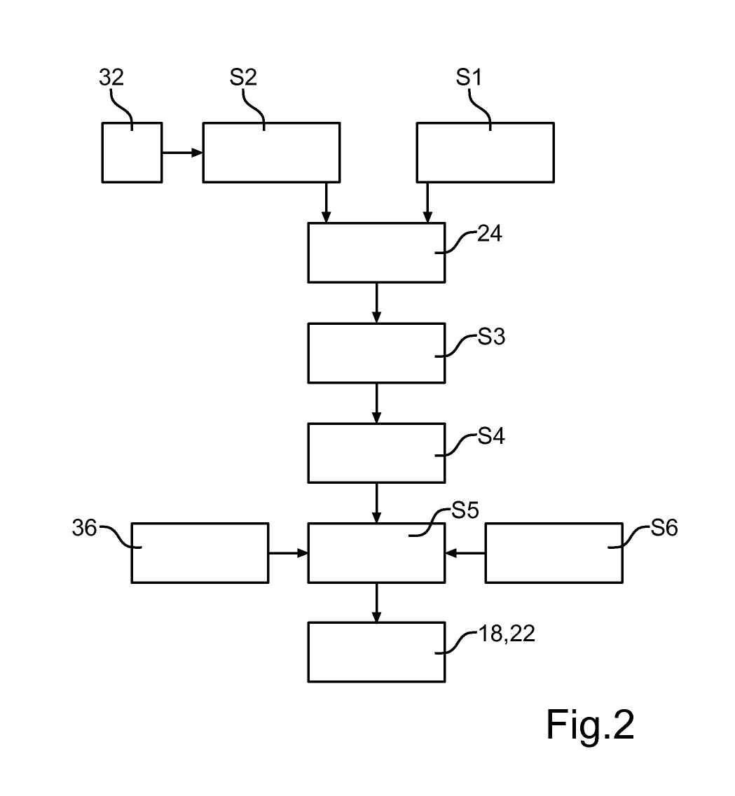

FIG. 2 a flow diagram for illustrating a method for transmitting messages to a mobile radio device in the system according to FIG. 1.

FIG. 1 shows an institution 10, which is for example exhibition grounds or an exhibition hall with a plurality of exhibition stands 12a-g. An entrance 14 is associated with the institution 10, via which persons can get to the institution 10. Presently, the entrance 14 is a person entrance, via which the persons can enter the institution 10. The entrance 14 for example includes a pass-through with a turnstile.

Further, an exit 16 is associated with the institution 10, via which the persons can again exit the institution 10. The exit 16 is presently a person exit.

In FIG. 1, a person 18 is shown, who is in possession of a mobile radio device, presently in the form of a mobile phone 20. Therein, the mobile phone 20 is connected to a mobile radio network. The person 18 is also referred to as user 22 of the mobile phone 20. The user 22 also possesses an entrance element, which is referred to as entrance ticket 24 and which authorizes the user 22 to enter the institution 10 via its entrance 14.

A detecting device 26 of a system 11 is disposed at the entrance 14 of the institution 10. The entrance ticket 24 and the detecting device 26 are configured to act with each other, wherein the detecting device 26 is also configured to detect passage of the entrance 14 by the user 22 and thus entry of the institution 10 by the user 22 as a result of the interaction with the entrance ticket 24.

For the interaction with the detecting device 26, the entrance ticket 24 for example has a bar code 28. For interaction with the entrance ticket 24, the detecting device 26 has an optical detecting means 30, by means of which the bar code 28 is optically detectable, e.g. to be scanned. To this, the user 22 moves the entrance ticket 24 or its bar code 28 into a detection range of the optical detecting means 30.

Therein, the interaction of the entrance ticket 24 with the detecting device 26 via the bar code 28 and the optical detecting means 30 is effected independently of a mobile radio network and in particular independently of the mobile radio network, to which the mobile phone 20 is connected or coupled.

In FIG. 2, two possibilities are schematically illustrated, how the user 22 can enter in possession of the entrance ticket 24. A first one of the possibilities is illustrated by a first step S1. In the first step S1, the user 22 purchases the entrance ticket 24 on site at the institution 10, for example at an entrance box office.

The second possibility is illustrated by a second step S2. In the second step S2, the user 22 purchases the entrance ticket 24 online, i.e. via the Internet or via a website associated with the institution 10 in the Internet and prints the entrance ticket 24 for example by means of a printer. For purchasing the entrance ticket 24 in the second step S2, for example, at least one coupon 32 is available to the user 22. Within the scope of the purchase of the entrance ticket 24 both in the first step S1 and in the second step S2, the user 22 specifies his email address as well as a declaration of consent to privacy, which are stored, i.e. are saved, in a storage means of the system 11. The storage means is for example integrated in the detecting device 26 or in a transmitting device 34 of the system 11 coupled to the detecting device 26.

In FIG. 2, the interaction of the entrance ticket 24 with the detecting device 26 is effected in a third step S3. As a result of the interaction of the entrance ticket 24 with the detecting device 26—as is illustrated by a fourth step S4—a triggering signal is communicated from the detecting device 26. Therein, the transmitting device 34 coupled to the detecting device 26 is configured to receive the triggering signal. In a fifth step S5, a first message in the form of a first email is communicated to the mobile phone 20 via the mobile radio network by means of the transmitting device 34—since the declaration of consent to privacy as well as the email address of the user 22 are stored.

The content of the first message as well as of possible further messages in the form of emails to the mobile phone 20 and thereby to the user 22 are therein for example provided by respective persons 36, which operate the institution 10 (exhibition) and/or the exhibition stands 12a-g.

By this purposeful communication of the first email to the mobile phone 20 and thus to the user 22, the user 22 can be purposefully provided with information to the institution 10 and thereby to the environment of the user 22, without the user 22 having to get active by himself and search for the information. Therein, the email automatically reaches the user 22 and only if he actually has entered the institution 10.

Preferably, it is provided that the user 22 performs at least one user-specific specification upon purchase of the entrance ticket 24, i.e. in the first step S1 or in the second step S2. This user-specific specification can for example include fields of interest of the user 22. Thereby, the user 22 can be informed about which of the exhibition stands 12a-g at least substantially correspond(s) to his interests by means of the email in purposeful and adequate manner. This means that the user 22 orients himself in particularly simple and comfortable manner at or in the institution 10 and can purposefully visit those of the exhibition stands 12a-g, which at least substantially correspond to his interests.

Therein, the email can be written in German and/or English language. Preferably, the creation of the email or the creation of its content is effected depending on the time. Thus, it is possible to provide the user 22 from the time of his passage of the entrance 14 for example only with such information about events, which are still imminent in time. Thus, the information of the user 22 about events at the exhibition stands 12a-g already past in time can be avoided.

Further, it is possible to communicate at least one further email to the mobile phone 20. Therein, the communication of the at least one further email can be effected depending on the time. Thereby, the user 22 can be kept informed about changes of the institution 10 over the time.

Further, it is possible that the mobile phone 20 is configured to determine its and thereby the position of the user 22 relative to the institution 10 via a satellite-based positioning system. Therein, the communication of the at least one further email can be performed depending on positions of the user 22 relative to the institution 10.

If the user 22 with his mobile phone 20 is for example in a first position A, thus, he for example obtains a further email with information about the exhibition stands 12f and g.

If the user 22 is for example in a second position B, thus, the user 22 obtains information only about the exhibition stands 12d and e. Thereby, the information or the contents of the respective email can be filtered and matched to the position of the user 22 in order to thus avoid information flood overstraining the user 22.

The possibility of positioning by means of the mobile phone 20 via the satellite-based positioning system also allows detecting exit of the user 22 from the institution 10 via the exit 16. For example, if the positioning reveals that a distance between the current position of the user 22 and the institution 10 is greater than a presettable threshold value, thus, exiting the institution 10 by the user 22 can be inferred. Thereupon, in a sixth step S6, the communication of emails to the mobile phone 20 can be terminated or the communication of further emails to the mobile phone 20 can be avoided.

The institution 10 can also be a single building, a vehicle such as for example a surface vehicle, an aircraft or a water craft. Similarly, the institution 10 can be an area, for example a skiing area, wherein the entrance 14 is an entrance to a ski-lift of the skiing area. Further, the institution 10 can also be a highway section of a highway network. Therein, the entrance 14 is for example a portal, which the user 22 passes riding in a motor vehicle.

### LIST OF REFERENCE CHARACTERS

10 institution
11 system
12a-g exhibition stand
14 entrance
16 exit
18 person
20 mobile phone
22 user
24 entrance ticket
26 detecting device
28 bar code
30 optical detecting means
32 coupon
34 transmitting device
36 person
A first position
B second position
S1 first step
S2 second step
S3 third step
S4 fourth step
S5 fifth step
S6 sixth step

1. A system for automatically transmitting at least one message via at least one mobile radio network to at least one mobile radio device, the system including at least one detecting device disposed at an entrance to an institution, which is the detecting device configured to detect passage of the entrance by a user of the mobile radio device as a result of an interaction of an entrance element of the user with the detecting device independent of a mobile radio network and to communicate at least one triggering signal as a result of the detection of the passage, the system further including a transmitting device coupled to the detecting device, which is configured to receive the triggering signal and to communicate the at least one message to the mobile radio device as a result of reception of the triggering signal.

2. The system according to claim 1, wherein the entrance element (24) is an entrance ticket (24) formed from paper and/or plastic.

3. The system according to claim 1, wherein the entrance element and the detecting device are configured to interact with each other via electromagnetic waves for detecting the passage of the entrance.

4. The system according to claim 3, wherein the entrance element includes at least one RFID chip for interacting with the detecting device via electromagnetic waves.

5. The system according to claim 1, wherein the entrance element and the detecting device are configured to interact with each other such that the entrance element can be at least partially introduced into a receiving opening of the detecting device.

6. The system according to claim 1, wherein the entrance element has at least one optically detectable pattern, wherein the detecting device includes at least one optical detecting means, by means of which the optical pattern of the entrance element can be detected for interaction of the detecting device with the entrance element.

7. The system according to claim 1, wherein the system includes at least one further detecting device, wherein the further detecting device and the mobile radio device are configured to determine a relative position of the mobile radio device to the institution by means of a positioning system.

8. The system according to claim 7, wherein the positioning system is a satellite-based positioning system.

9. A method for automatically transmitting at least one message via at least one mobile radio network to at least one mobile radio device, including the steps of:
detecting passage of an entrance to an institution by a user of the mobile radio device by means of a detecting device disposed at the entrance as a result of an interaction of an entrance element of the user with the detecting device independent of a mobile radio network,
transmitting at least one triggering signal by means of the detecting device as a result of the detection of the passage,
receiving the triggering signal by a transmitting device coupled to the detecting device, and
transmitting the at least one message to the mobile radio device by means of the transmitting device as a result of the reception of the triggering signal.

10. The method according to claim 9, wherein at least one message is communicated depending on at least one presettable, user-specific specification.

11. The method according to claim 9, wherein at least one further message is communicated to the mobile radio device via the mobile radio network.

12. The method according to claim 11, wherein at least one further message is communicated depending on the time and/or on a position of the mobile radio device relative to the institution.

13. The method according to claim 9, wherein the communication of messages via mobile radio to the mobile radio device is terminated depending on a position of the mobile radio device relative to the institution.

14. The method according to claim 13, wherein the communication of messages is terminated if a distance of the mobile radio device from the institution exceeds a presettable threshold value.

15. The method according to claim 9, wherein the communication of messages via mobile radio to the mobile radio device is terminated depending on the time.
